(19) United States
(12) Patent Application Publication
(10) Pub. No.: US 2004/0247289 A1
(43) Pub. Date: Dec. 9, 2004

(54) Image security system and method for protecting privacy

(75) Inventor: Hee Wook Choi, Yongin-city (KR)

Correspondence Address: BACON & THOMAS, PLLC, 625 SLATERS LANE, FOURTH FLOOR, ALEXANDRIA, VA, 22314

(73) Assignee: Picaso Info Communication Co., Ltd., Sugnam-city (KR)

(21) Appl. No.: 10/853,224

(22) Filed: May 26, 2004

(30) Foreign Application Priority Data
Jun. 3, 2003 (KR) 10-2003-0035501

(51) Int. Cl. H04N 5/76; H04N 7/00; H04N 7/167

(52) U.S. Cl. 386/94; 380/201

(57) ABSTRACT

Disclosed is an image security system including the digital video recorder and method thereof. More specifically, the present invention relates to a method and system for modulating image data using a predetermined encrypting algorithm to protect privacy of an individual.

An image security system according to the present invention includes an image receiving and inputting part for receiving image data from a camera connected to the digital video recorder, an image modulating part for modulating the received image data using a predetermined encrypting algorithm, a storing part for storing the modulated image data, and a display part for replaying the modulated image data.

According to the present invention, there is provided a method and apparatus, capable of protecting privacy of an individual by modulating the image data of the image security system including the digital video recorder.

### BACKGROUND OF THE INVENTION

1. Field of the Invention

The present invention relates to an image security system including a digital video recorder and method thereof, and more particularly to a method and system for modulating image data using a predetermined encrypting algorithm in order to protect privacy of an individual.

2. Description of the Prior Art

In preparation for increasing crimes as society develops rapidly, the analog type CCTV(Closed Circuit Television) has been generally installed, but many problems have been generated in such analog type CCTV. Therefore, a security equipment of high performance, capable of replacing such analog type CCTV is required and a digital image supervising system capable of meeting such demand has finally come into the world.

A digital video recorder not only compensates for the problems of the analog CCTV, but also possibly provides, in an easy manner, supervising of a remotely located area and a variety of convenient functions that are even unimaginable in the conventional CCTV, so that the digital video recorder has rapidly settled down as a key product of the security market.

The analog CCTV generally used up to now has the problems that the image quality gets deteriorated as recording is repeatedly performed since it has adopted the method of repeatedly performing recording many times on a video tape and the video tape should be replaced when a predetermined period of time elapses, which have been very inconvenient. To resolve those problems, the digital video recorder has been developed. Since the digital video recorder uses a hard disk or a digital video disk (DVD) instead of the video tape and stores image data in a digital method, the image quality is not deteriorated even when recording is repeatedly performed many times, and it is easy to replay or search the stored image. Further, since the image is stored in form of a digital signal, the digital video recorder has strong points of easily editing and transferring the image. Also, according to the digital video recorder, it is possible to search the image on a camera basis, an event basis, as well as a time basis, a date basis, and it is possible to perform a real-time supervising, searching, backup, and camera control even from a far distant place.

Also, since the digital video recorder records the image on a hard disk, there is no inconvenience of buying a video tape as was done in the conventional analog CCTV and there are no additional costs such as maintenance costs of a video tape, which are economical considerably. Also, since enlargement and reduction functions, and remote printing together with fast and easy-to-use searching function, can be basically provided, the digital video recorder is being rapidly adopted for a security apparatus of a financial organization where crimes may frequently occur.

But, in case of receiving and recording image data using the digital video recorder in a space like a rest room where privacy of an individual is required, there is possibility that privacy of an individual might be infringed. Therefore, there is a problem that it is difficult to record image data using the digital video recorder in a place where infringement of individual privacy is concerned.

FIG. 1 is a view showing an image security system for receiving image data from a camera according to the conventional art. As shown in FIG. 1, an image security system 104 including the digital video recorder is connected to cameras 101, 102, and 103, so that it is possible to replay and record, in real time, the image data received from the cameras 101, 102, and 103, and searching on a data basis and a time basis are also possibly performed.

For example, since a robbery frequently occurs in a public bath, a camera for supervising in real time may be installed in such place. But, in that case, there is high possibility that the supervision camera for recording the image for prevention of a robbery or in preparation for an eventual accident, might be abused as a hidden camera by a third party. Since the hidden camera reveals faces of unspecified persons in real time, there is possibility of infringing a portrait right. Further, in case of installing the supervision camera in a place, that may arouse sexual shame, like a public bath or a dressing room, it goes without saying that the consequences thereof will be enormous.

Therefore, installing such image system in a public place is viewed as a considerably sensitive problem to the general public, and, recently, also the press begins to deal with the above matter in a serious manner.

But, if a person as an object constituting the image recorded by the image system is not clearly distinguished and image is processed so that merely outline is distinguishable and only movement is known, controversy regarding infringement of a portrait right in case of the hidden camera, will be weakened.

Also, there is a need for the digital video recorder, wherein an image is processed in such a way that each person is not clearly distinguished even in a place like a general office, a bank, for protection of privacy of an individual working in the office and, only in case a problem occurs afterward, the processed image is restored so that relevant image may be searched.

### SUMMARY OF THE INVENTION

To solve the above-indicated problems, it is, therefore, an object of the present invention to protect privacy of an individual by modulating image data of an image security system including a digital video recorder.

It is another object of the present invention to provide an image security method and system, capable of protecting individual privacy and performing a supervising function to some extent, by making it possible to understand an outline of an object constituting the image so that merely the object's movement may be possibly captured but understanding of exact image may be difficult, in a method for modulating the image data.

It is still another object of the present invention to provide an image security method and system, capable of restoring image data using a predetermined restoring algorithm in case an accident occurs in connection with the modulated image data.

### BRIEF DESCRIPTION OF THE DRAWINGS

FIG. 1 is a view showing an image security system for receiving image data from a camera according to the conventional art.

FIG. 2 is a block diagram showing an inner structure of an image security system according to the present invention.

FIGS. 3A and 3B are detailed flowcharts of a method for modulating and demodulating an image according to the image security system of the present invention.

FIG. 4 is a view showing a method for modulating the image data using a predetermined encrypting algorithm according to an embodiment of the present invention.

FIGS. 5A and 5B are views showing an example of the received image data and the image data modulated from the received image data, respectively.

FIG. 6 illustrates a typical computer system in accordance with an embodiment of the present invention.

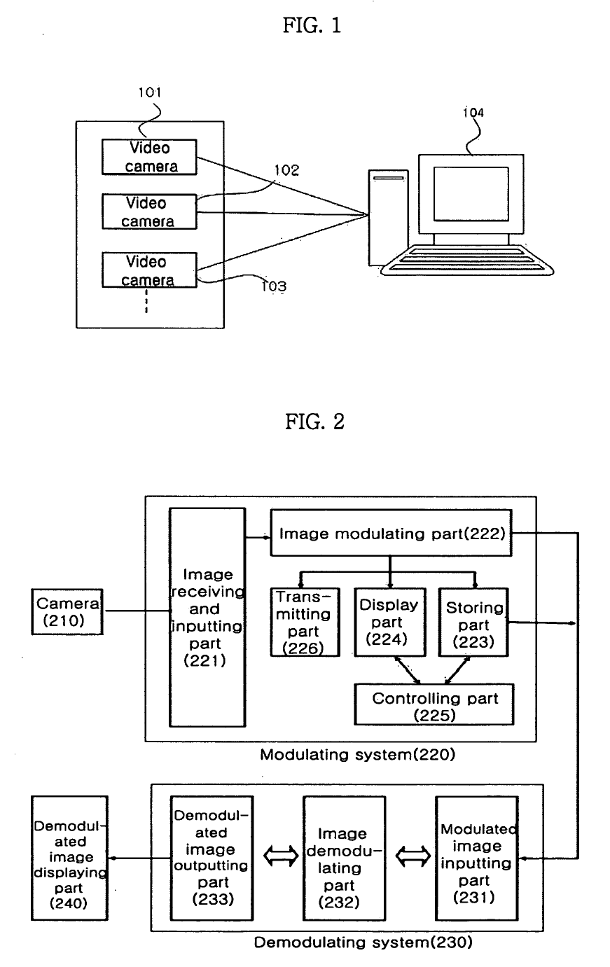

### DETAILED DESCRIPTION OF THE PREFERRED EMBODIMENT

To achieve the objects and overcome the problems in the prior art, the present invention provides an image security system including a digital video recorder, the system comprising: an image receiving and inputting part for receiving image data from a camera connected to the digital video recorder, an image modulating part for modulating the received image data using a predetermined encrypting algorithm, a storing part for storing the modulated image data, and a display part for replaying the modulated image data. The image modulating part modulates the received image data in such a way that an outline of an object constituting the modulated image data is distinguishable. In addition to the present invention provides the system further comprising an image demodulating part for restoring the modulated image data back to the initially received image data using a demodulating algorithm related to the predetermined encrypting algorithm.

According to aspect of the present invention, there is provided an image security method for a digital video recorder, the method comprising the steps of: receiving image data from a camera connected to the digital video recorder, modulating the received image data using a predetermined encrypting algorithm, storing the modulated image data, replaying the modulated image data, and restoring the modulated image data back to the received image data using a predetermined demodulating algorithm related to the predetermined encrypting algorithm.

A preferred embodiment of the present invention will now be described with reference to the accompanying drawings.

FIG. 2 is a block diagram showing an inner structure of an image security system according to the present invention. Referring to FIG. 2, the present invention comprises: a camera part 210; a modulating system 220; a demodulating system 230; and a demodulated image displaying part 240. The modulating system 220 and the demodulating system 230 may be included in the same digital video recorder, or may be provided as a separate system.

The modulating system 220 comprises: an image receiving and inputting part 221; an image modulating part 222; a storing part 223; a display part 224; a controlling part 225; and a transmitting part 226.

The image receiving and inputting part 221 performs a function of interfacing with the camera 210, by receiving image data from the camera 210 connected to the digital video recorder.

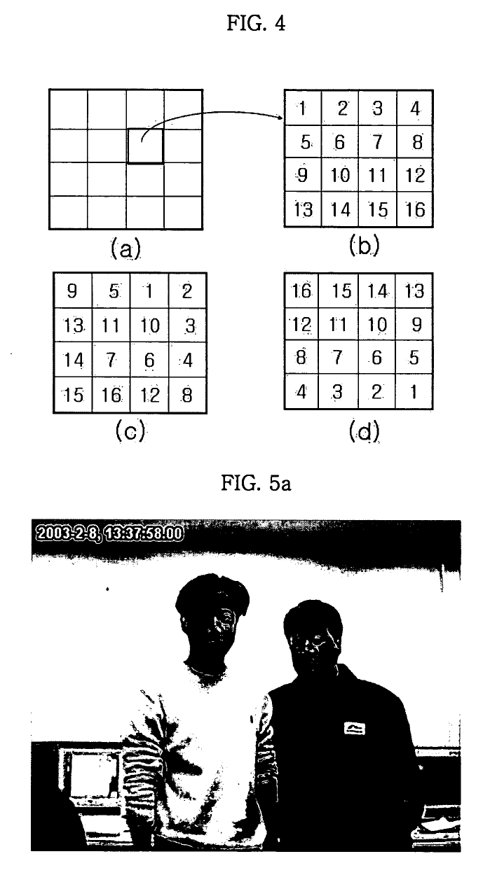

The image modulating part 222 modulates the image data received through the image receiving and inputting part 221 using a predetermined encrypting algorithm. At the moment, the image modulating part 222 modulates the image data received by the image receiving and inputting part 221 so that an only outline of an object constituting the modulated image data may be distinguishable. In order for the outline of the object constituting the image data to be distinguishable, according to the embodiment of the present invention, the received image data is divided in a plurality of blocks having a predetermined size and the position of a pixel constituting the block is changed within the block according to a predetermined rule. The embodiment of the above-mentioned position change of the pixel will be described in detail with reference to FIG. 4. In case the image modulating part 222 modulates the image data, the image data is modulated with use of a predetermined key value, and when demodulated by the demodulating system 230 afterward, the image data can be demodulated with use of the above key value or other key value related to the above key value.

The modulated image data is stored and maintained by the storing part 223, and the stored image data can be searched in real time, so that the searched image data can also be displayed by the display part 224. At the moment, the image data displayed on a predetermined display apparatus such as a CRT(Cathode Ray Tube) and an LCD(Liquid Crystal Display) is the image data modulated by the image modulating part 222 in such a way that merely the outline of an object is understood. Therefore, an exact object cannot be distinguished but merely the outline is distinguishable.

The controlling part 225 plays a role of controlling each constituent module of the modulating system 220.

The transmitting part 226 is intended for transmitting the modulated image data to a predetermined terminal (not shown) or other apparatus connected to the modulating system 220 through a network. The terminal may be other digital video recorder and may be a terminal such as a computer terminal, capable of replaying or storing the modulated image data.

The demodulating system 230 for restoring the modulated image data to the original image in case a problem occurs in connection with the modulated image data, may comprise: a modulated image inputting part 231; an image demodulating part 232; and a demodulated image outputting part 233.

The modulated image inputting part 231 performs a function of receiving the modulated image data. For a case where the problem occurs in connection with the modulated image data, there exist the case that an object constituting the modulated image commits a crime such as a robbery or a violence, or the case that a problem such as a robbery has occurred at the time when the object has been recorded by the camera (i.e., at the time when the object has been stored in the image storing part). In those cases, the modulated image data needs to be restored, for the restored image can become an evidence of the investigation authorities. For example, in case a bank robbery occurs while recording is performed in form of the modulated image data with use of the digital video recorder of the present invention, it is required that the modulated image data is demodulated so that the original image data can be searched in order to find a suspect of the above bank robbery case. Therefore, in order to restore the modulated image data to the original image, the modulated image inputting part 231 of the demodulating system 230 should be provided with the image data in connection with which the problem has occurred.

The image demodulating part 232 plays a role of restoring the image data input from the modulated image inputting part 231, to the original image data. Namely, the image demodulating part 232 restores the modulated image data back to the image data of that time when the image was received before modulation by the image modulating part 222. More specifically, the image demodulating part 232 restores the modulated image data back to the original image data using a demodulating algorithm that corresponds to a modulating algorithm by the image modulating part 222.

The demodulated image outputting part 233 plays a role of outputting the image data restored back to the original image data, to the demodulated image displaying part 240. The image that falls under suspicion is identified through replaying of the image on the demodulated image displaying part 240, whereby the identified image may become an evidence of the investigation authorities and the possibility of causing disadvantage to other person or misunderstanding can be removed.

Preferably, since having the purpose of protecting privacy of an individual, the demodulating system 230 is used in case the problem like above occurs. Also, preferably, the demodulating system 230 is used under presence of the investigation authorities on condition that the recorded image data is not open to the general public. Namely, since the demodulating system 230 has the possibility of infringing individual privacy, it is possible to get the demodulating system 230 to be installed in a predetermined government and public office such as a police station, or to be used under presence of a policeman. Or, it is also possible to get the government authority to maintain a key value related to demodulation by the demodulating system 230, or to get a trustworthy third organization to maintain the key value so that the image data can be restored to the original image only upon occurrence of a problem afterward.

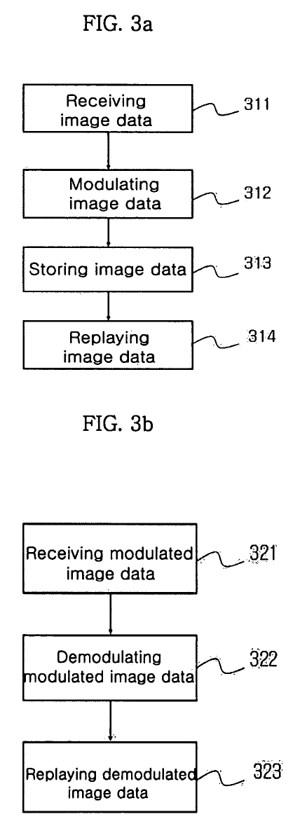

FIGS. 3A and 3B are detailed flowcharts of a method for modulating and demodulating an image according to the image security system of the present invention.

Referring to FIG. 3A, the step of 311 receives image data from the camera 210. The camera 210 may be more than one unit and connected through wire or wirelessly, to the image security system including the digital video recorder.

The step of 312 modulates the received image data using a predetermined encrypting algorithm. Since the received image data contains a clear face of an object constituting the image and there is possibility of infringing a portrait right, modulation for making the image seen as a mosaic pattern is performed, whereby exposure of a personal identity can be prevented. But, at the step of 312, it is preferable that the outline of an object constituting the modulated image data is distinguishable by everybody upon modulation of the image data. Such outline is intended for satisfying, to some extent, a supervision function which is an original purpose of the digital video recorder.

A method for modulating the image data according to an embodiment of the present invention, divides the received image data into a plurality of blocks having a predetermined size, and changes a position of a pixel constituting the blocks within the blocks according to a predetermined rule.

On the first place, a method for modulating the received image data at the step of 312 will be described with reference to FIG. 4, and subsequently the step of 313 and the following steps will be described below.

FIG. 4 is a view showing a method for modulating the image data using a predetermined encrypting algorithm according to an embodiment of the present invention.

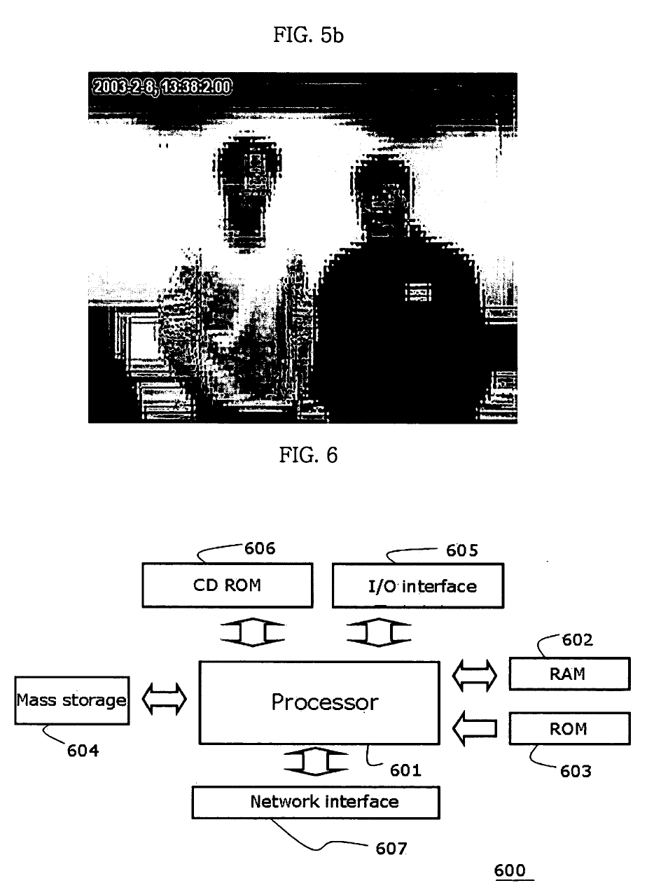

FIG. 4A shows that the received image data is divided into the blocks of a predetermined size. In the above drawing, for convenience in explanation, one frame constituting an image is divided in a 4 by 4 matrix shape along its horizontal and vertical lines. For example, one frame of the image data like FIG. 5A is divided into the blocks of a predetermined size.

FIG. 4B is an enlarged view of one of sixteen blocks in FIG. 4A. The blocks in FIG. 4B consists of sixteen pixels of 4 by 4 matrix. Numbers from 1 to 16 are given to each of sixteen pixels within the block in FIG. 4B. Namely, number 1 through number 4 are positioned on the first row, 5 through 8 on the second row, 9 through 12 on the third row, 13 through 16 on the fourth row, respectively. FIGS. 4C and 4D show that the positions of each pixel are changed according to a predetermined rule.

FIG. 4C shows the positions of each pixel in FIG. 4B are changed by rotating the positions of each pixel clockwise as much as two unit. If the positions of the pixels are changed according to the above rule with reference to FIG. 4B, number 9, number 5, number 1, and number 2 are positioned in order on the first row, 13,11,10, and 3 on the second row, 14,7,6, and 4 on the third row, 15,16,12, and 8 on the fourth row which is the last row, respectively, as shown in FIG. 4C.

For another example, FIG. 4D is a view showing that the positions of the pixels are changed according to a rule of up-down and right-left symmetry around the center of the block. If the positions of the pixels are changed according to the rule as shown in FIG. 4D, number 16, number 15, number 14, and number 13 are positioned in order on the first row, 12,11,10, and 9 on the second row, 8,7,6, and 5 on the third row, 4,3,2, and 1 on the fourth row, respectively.

FIG. 4 is a mere embodiment of the present invention, and a variety of methods for changing the positions of the pixels within the block using a predetermined algorithm besides the above-described methods, may be used.

If the positions of the pixels are changed within the block according to a predetermined rule as described above, the image within the block is changed, which appears as a mosaic effect. Therefore, the original image data cannot be exactly distinguishable, but the outline of each object constituting the image data is distinguishable.

The foregoing algorithm is one of embodiments of the present invention, and a variety of image demodulating algorithms, wherein exact distinguishing each object constituting the image data is not possible but distinguishing the outline of the object is possible within the spirit and scope of the present invention, can be used.

In the following, the step of 313 and the subsequent steps of FIG. 3A will be described.

The step of 313 stores the modulated image data. The stored image data needs to be maintained so that the modulated image data is searched and restored back to the original image and replayed in case a problem occurs. The step of 314 is the step of replaying the modulated image data. The modulated image data is possibly replayed in a visual or an auditory manner at the display part 224. In case the image data is replayed, it is difficult to exactly understand the object, but movement of the object constituting the image data can be easily understood.

FIG. 3B shows a method for restoring the modulated image data back to the original image data of that time of reception in case a problem occurs in connection with the modulated image data.

At the step of 321, the modulated image inputting part 231 of the demodulating system 230 receives the modulated image data. The step of 322 restores the received modulated image data back to the original image data initially received by the image receiving and inputting part 221 using a demodulating algorithm which is related to a predetermined encrypting algorithm. The step of 323 outputs the image data restored back to the originally received image data, to the demodulated image displaying part 240.

FIGS. 5A and 5B are views showing an example of the received image data and the image data modulated from the received image data, respectively. FIG. 5A shows the original image data received from the camera 210. The image data shown in FIG. 5A is received by the image receiving and inputting part 221 through the camera and modulated by the image modulating part 222 and stored in the storing part 223. Therefore, a user cannot see the original image data of FIG. 5A merely using the digital video recorder. If the image data is modulated according to the embodiment of the present invention, the mosaic effect as shown in the image data of FIG. 5B, may appear. In the image data of FIG. 5B, the object constituting the image, i.e. two persons as shown in the image data of FIG. 5A, is not clearly recognized, but only the outline of the object can be understood. Therefore, in case the image is a moving image, the movements of the object may be distinguishable. If a predetermined problem occurs, the moving image is restored back to the original image data as shown in FIG. 5A, by the image demodulating part 232 of the demodulating system 230.

In addition, embodiments of the present invention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc.

Examples of program instructions include both machine code, such as produced by a compiler, and files containing higher level code that may be executed by the computer using an interpreter.

FIG. 6 illustrates a typical computer system in accordance with an embodiment of the present invention.

The computer system includes any number of processors 640 (also referred to as central processing units, or CPUs) that are coupled to storage devices including primary storage 660 (typically a random access memory, or “RAM”), primary storage 670 (typically a read only memory, or “ROM”). As is well known in the art, primary storage 660 acts to transfer data and instructions uni-directionally to the CPU and primary storage 660 is used typically to transfer data and instructions in a bi-directional manner. Both of these primary storage devices may include any suitable type of the computer-readable media described above. A mass storage device 610 is also coupled bi-directionally to CPU 640 and provides additional data storage capacity and may include any of the computer-readable media described above. The mass storage device 610 may be used to store programs, data and the like and is typically a secondary storage medium such as a hard disk that is slower than primary storage. A specific mass storage device such as a CD-ROM 620 may also pass data uni-directionally to the CPU. Processor 640 is also coupled to an interface 630 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 640 optionally may be coupled to a computer or telecommunications network using a network connection as shown generally at 650 With such a network connection, it is contemplated that the CPU might receive information from the network, or might output information to the network in the course of performing the above-described method steps. The above-described devices and materials will be familiar to those of skill in the computer hardware and software arts.

As described in detail above, according to the present invention, there is provided a method and apparatus, capable of protecting privacy of an individual by modulating the image data of the image security system including the digital video recorder.

Also, according to the image security system of the present invention, there is provided a method for modulating image data, the image security method and system capable of protecting individual privacy and performing a supervising function to some extent, by making it possible to understand an outline of an object constituting the image so that merely the object's movement may be possibly captured but understanding of exact image may be difficult.

According to the present invention, the image security method and system is capable of restoring image data using a predetermined restoring algorithm in case an accident occurs in connection with the modulated image data.

While the invention has been shown and described with reference to certain preferred embodiments thereof, the invention is not limited to those embodiments but it will be understood by those skilled in the art that various changes in form and details may be made therein without departing from the spirit and scope of the invention as defined by the appended claims.

What is claimed is:

1. An image security system including a digital video recorder, the system comprising:
an image receiving and inputting part for receiving image data from a camera connected to the digital video recorder;
an image modulating part for modulating the received image data using a predetermined encrypting algorithm;
a storing part for storing the modulated image data; and
a display part for replaying the modulated image data.

2. The system according to claim 1, wherein the image modulating part modulates the received image data in such a way that an outline of an object constituting the modulated image data is distinguishable.

3. The system according to claim 1, wherein the image modulating part divides the received image data into a plurality of blocks having a predetermined size and changes positions of pixels constituting the blocks within the blocks according to a predetermined rule.

4. The system according to claim 3, further comprising an image demodulating part for restoring the modulated image data back to the initially received image data by restoring the positions of the pixels constituting each block of the modulated image data, to their original positions within the block.

5. The system according to claim 1, further comprising an image demodulating part for restoring the modulated image data back to the initially received image data using a demodulating algorithm related to the predetermined encrypting algorithm.

6. The system according to claim 1, further comprising a transmitting part for transmitting the modulated image data to a predetermined terminal.

7. An image security method for a digital video recorder, the method comprising the steps of:
receiving image data from a camera connected to the digital video recorder;
modulating the received image data using a predetermined encrypting algorithm;
storing the modulated image data;
replaying the modulated image data; and
restoring the modulated image data back to the received image data using a predetermined demodulating algorithm related to the predetermined encrypting algorithm.

8. The method according to claim 7, wherein the encrypting algorithm is such algorithm that modulates the received image data in such a way that an outline of an object constituting the modulated image data is distinguishable.

9. A computer-readable recording medium in which a program for performing a method according to claim 7 is recorded.

10. A computer-readable recording medium in which a program for performing a method according to claim 8 is recorded.
